(19) United States
(12) Patent Application Publication
(10) Pub. No.: US 2009/0084017 A1
(43) Pub. Date: Apr. 2, 2009

(54) DEER DECOY

(76) Inventor: John L. Hershberger, Middlefield, OH (US)

Correspondence Address: TAROLLI, SUNDHEIM, COVELL & TUMMINO L.L.P., 1300 EAST NINTH STREET, SUITE 1700, CLEVEVLAND, OH, 44114, US

(21) Appl. No.: 12/238,474

(22) Filed: Sep. 26, 2008

Related U.S. Application Data
(60) Provisional application No. 60/976,070, filed on Sep. 28, 2007.

(51) Int. Cl. A01M 31/06

(52) U.S. Cl. 43/2

(57) ABSTRACT

An animal decoy is provided. The decoy comprises a body having an outer wall defining an inflatable inner chamber and a platform having a fluid passage therein and at least one nozzle disposed thereon. The at least one nozzle is in fluid communication with the fluid passage. The body is releasably attached to fee at least one nozzle to place the inflatable inner chamber in fluid communication with the fluid passage. A means for inflating the body is secured to the platform and is in fluid communication with the fluid passage to provide inflation fluid to the fluid passage. The inflation means is actuated remotely to supply inflation fluid to the fluid passage and inflatable inner chamber to inflate the body.

### RELATED APPLICATION

This application claims priority from U.S. provisional patent application Ser. No. 60/976,070, filed Sep. 28, 2007, the entirety of which is hereby incorporated by reference.

### TECHNICAL FIELD

The present invention is directed to animal decoys and, in particular, is directed to a remotely inflatable deer decoy.

### BACKGROUND OF THE INVENTION

Animal decoys are well known in the art. They have been used for years in the outdoors by hunters for luring wild game, or by homeowners to scare off unwanted creatures. Frequently these decoys arc made of lightweight foam or plastic and are of a unitary construction. The decoys, especially for larger animals such as deer, tend to be awkwardly shaped and thus difficult to carry or store. This becomes a safety concern where a hunter wishes to carry the decoy, along with his weapon, through the woods to the designated area. It is therefore beneficial to have an easily storable and portable decoy. The present invention satisfies this need by providing a collapsible and inflatable decoy that can be easily deployed or retracted and safely stored in a carry bag.

There is a further need to conceal the decoy until the hunter or landowner wishes it to be seen by other animals. This timing may occur due to the nature of the animals the decoy is used against, or particular hunting tactics employed by the hunter. Therefore, the present invention utilizes a remote activated or radio controlled element to remotely activate the decoy and cause its inflation from a distance when the hunter so desires.

### SUMMARY OF THE INVENTION

In accordance with the present invention, an animal decoy is provided. The decoy comprises a body having an outer wall defining an inflatable inner chamber and a platform having a fluid passage therein and at least one nozzle disposed thereon. The at least one nozzle is in fluid communication with the fluid passage. The body is releasably attached to the at least one nozzle to place the inflatable inner chamber in fluid communication with the fluid passage. A means for inflating the body is secured to the platform and is in fluid communication, with the fluid passage to provide inflation fluid to the fluid passage. The inflation means is actuated remotely to supply inflation-fluid to the fluid passage and inflatable inner chamber to inflate the body.

### BRIEF DESCRIPTION OF THE DRAWINGS

The foregoing and other features and advantages of the present invention will become apparent to those skilled in the art to which the present invention relates upon reading the following description with reference to the accompanying, drawings, in which:

FIG. 1 is a side elevational view showing an inflatable animal decoy system in accordance with an exemplary embodiment of the present invention;

FIG. 2 is a top view of the decoy of FIG. 1;

FIG. 3 is a sectional view of the body of FIG. 3;

FIG. 4 is an enlarged view of the front leg of FIG. 3;

FIG. 5 is a sectional view of the platform of FIG. 1;

FIG. 6A is a sectional view of the platform of FIG. 1 in the disassembled position, taken along line 6A-6A;

FIG. 6B is a plan view of the platform of FIG. 6A in the assembled condition;

FIG. 7A is a section view of the decoy of FIG. 1 in a partially inflated condition;

FIG. 7B is a section view of the decoy of FIG. 1 taken along line 7B-7B;

FIG. 8A is a side elevational view of the decoy of FIG. 1 in a deflated condition;

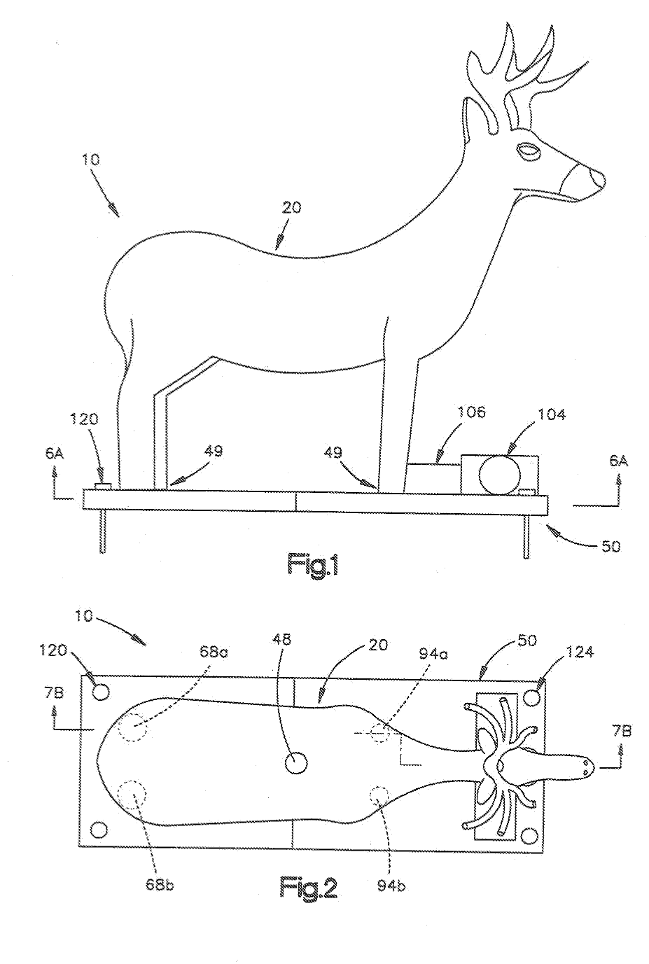

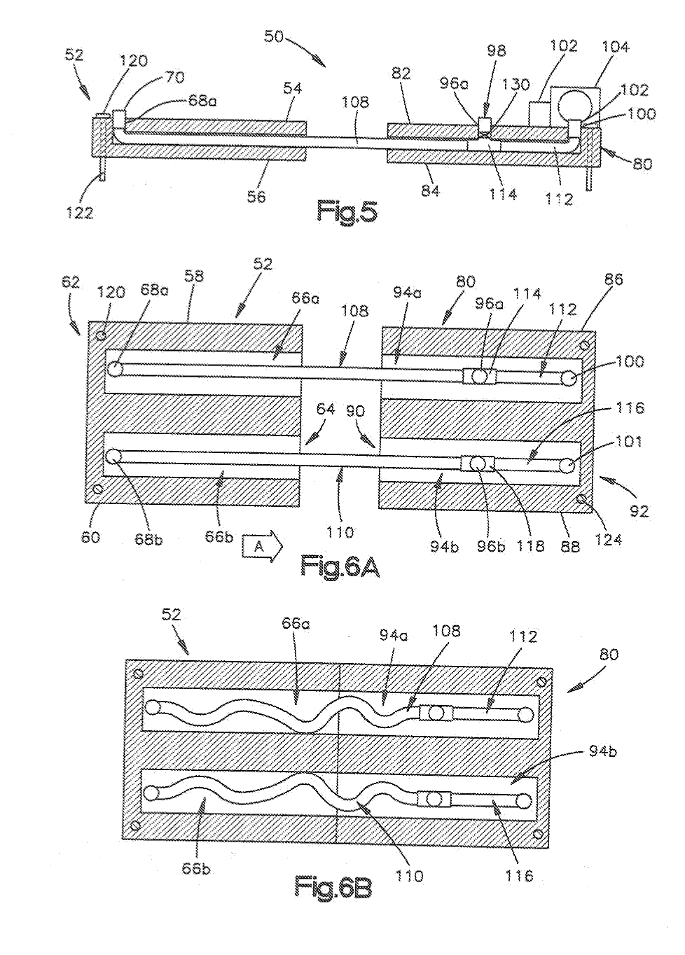

FIG. 5B is a side elevational view of the decoy of FIG. 1 in a partially inflated condition; and

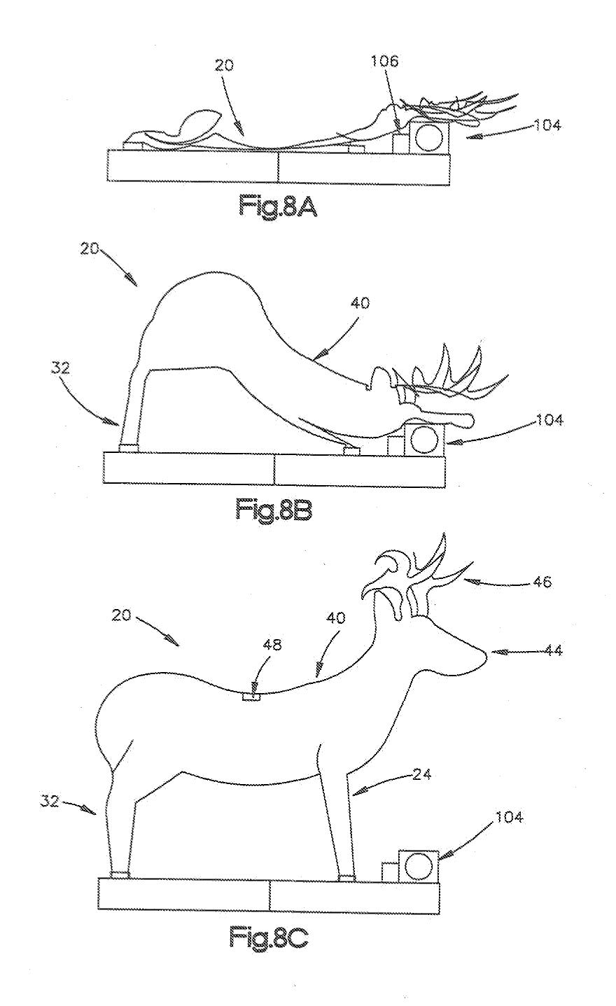

FIG. 8C is a side elevational view of the decoy of FIG. 1 in a fully inflated condition.

### DETAILED DESCRIPTION

Referring to FIGS. 1-2, a decoy system 10 is depicted, illustrating a preferred embodiment of the present invention. The system 10 comprises a body 20 and a platform 50. The body 20 assumes the shape of any forest creature, including, but not limited to, an elk, rabbit, caribou, moose, goose, deer, turkey, fox, or any other wild game. The use of a deer in the instant embodiment will be illustrative of the present invention. Inflation means 104 such as compressed air, a pump, or bottled nitrogen is attached to the platform 50, as is a remote control or radio controlled unit 106, the purpose of which will be hereafter described.

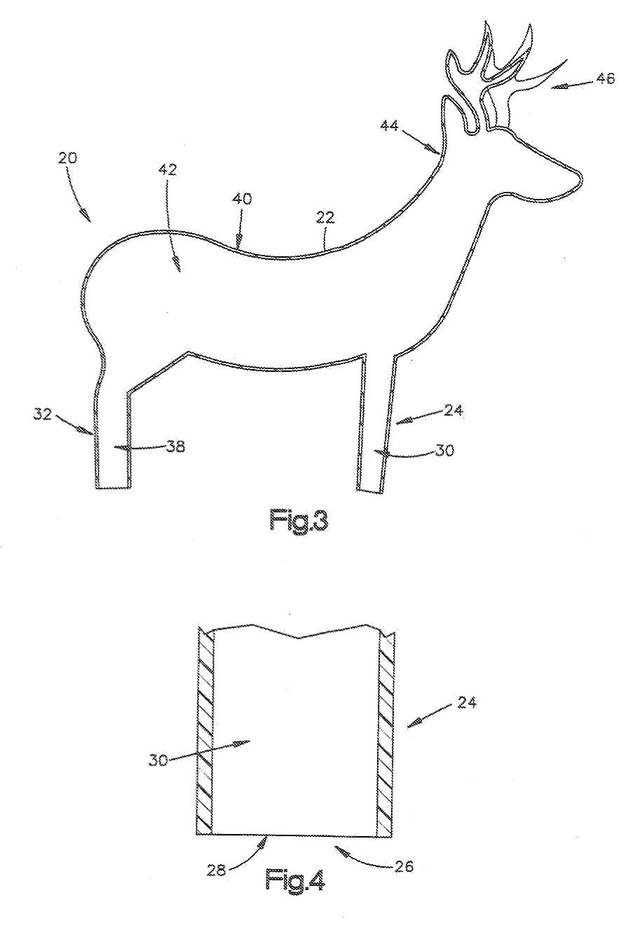

The body 20 is depicted in FIGS. 3-4. The body 20 comprises an outer wall 22 defining an inflatable inner chamber 42 capable of being filled with an inflation fluid, namely air. Although the wall 22 is depicted as being thin, it should be appreciated that the wall 22 may exhibit any thickness, thus varying the size of the inflatable chamber 42. The body 20 is made of material similar to that of other inflatable objects (e.g. vinyl, latex, or the like), or any otherwise non-rigid material capable of maintaining inflation fluid therein. The entire body 20 will be painted, stamped, or otherwise configured to mimic the coloring of a live deer. The body 20 comprises a torso 40 from which a head 44, antlers 46, a pair of front legs 24, and a pair of rear legs 32 extend. The inflatable chamber 42 extends through the torso 40, head 44, and antlers 46. The inflatable chamber 42 further extends through a passage 30 in each front leg 24 and a passage 38 in each rear leg 32. Each passage 30 in the front leg 24 terminates at an opening 28 in the distal end 26 of the front leg 24 (FIG. 4). Likewise, each passage 38 in the rear leg 32 terminates at an opening 36 in the distal end 34 of each rear leg 32 (not shown). As will be discussed, the opening 28 of each front leg 24 and the opening 36 of each rear leg 32 are configured to receive a nozzle disposed on the platform 50. A baffle 48 (FIG. 2) is disposed on the torso 40 to act as an inflation fluid escape means when deflation of the inflatable inner chamber 42 is desired.

The platform 50 onto which the body 20 is disposed is depicted in FIGS. 5-6B. The platform 50 comprises a first portion 52 and a second portion 80. Both portions 52, 80 are substantially rectangular in nature and are constructed of a light-weight plastic or polymer. The first portion 52 comprises a top surface 54, a substantially parallel bottom surface 56, and a pair of side walls 58, 60. The first portion 52 further includes a proximal end 62 and a distal end 64. A pair of air passages 66a, 66b are formed within the first portion 52 of the platform 50. Each passage 66a, 66b extends from the distal end 64 of the first portion 52 towards the proximal end 62, and lies between the top surface 54 and bottom surface 56 of the first portion 52. Each passage 66a, 66b is substantially rectangular in nature, although other shapes may be exhibited, and each passage 66a, 66b runs substantially parallel to the other. Each passage 66a, 66b terminates at a substantially circular opening 68a, 68b, respectively, at the top surface 54 of the first portion 52. Disposed within each opening 68a, 68b is a nozzle 70. Each nozzle 70 on the first portion 52 of the platform 50 will receive the opening 36 at the distal end 34 of each rear leg 32 of the body 20.

The first portion 52 may include at least, one stake 120 disposed within, an opening (not shown) to allow the first portion 52 to be secured to the ground when the decoy system 10 is in use. The stake 120 has a pointed end 122 for facilitating, penetration of the soil. This helps to prevent the platform 50, and thus the decoy system 10, from sliding along the ground or otherwise tipping over due to wind, etc.

The second portion 80 of the platform 50 is substantially similar to the first portion 52. The second portion 80 comprises a top surface 82, a substantially parallel bottom surface 84, and a pair of side walls 86, 88. The second portion 80 further includes a proximal end 90 and a distal end 92. A pair of air passages 94a, 94b are formed within the second portion 80 of the platform 50. Each passage 94a, 94b extends from the proximal end 90 of the second portion 80 towards the distal end 92, and lies between the top surface 82 and the bottom surface 84 of the second portion 80. Each passage 94a, 94b is substantially rectangular in nature, although other shapes may be exhibited, and each passage 94a, 94b runs substantially parallel to the other. Each passage 94a, 94b terminates at a substantially circular opening 96a, 96b, respectively, at the top surface 82 of the second portion 80. Disposed within each opening 96a, 96b is a nozzle 98. Each nozzle 98 on the second portion 80 of the platform 50 will receive the opening 28 at the distal end 26 of each front leg 24 of the body 20. The opening 96a in the passage 94a further includes a valve 130, the purpose of which will be discussed below. Likewise, the opening 96b in the passage 94b further includes a valve 132.

The passage 94a in the second portion 80 further extends toward the distal end 92 of the second portion 80 and terminates at a substantially circular opening 100 on the top surface 82 of the second portion 80. Disposed within this opening 100 is a fitting 102 that will be coupled to the inflation means 104. Likewise, the passage 94b in the second portion 80 further extends toward the distal end 92 of the second portion 80 and terminates at a substantially circular opening 101 on the top surface 82 of the second portion 80. Disposed within this opening 101 is a fitting 103 (not shown) that will also be coupled to the inflation means 104.

The second portion 80 may also include at least one slake 124 disposed within an opening (not shown) to allow the second portion 80 to be secured to the ground when the decoy system 10 is in use. The stake 124 has a pointed end 126 for facilitating penetration of the soil. This helps to prevent the platform 50, and thus the decoy system 10, from sliding along the ground or otherwise tipping over due to wind, etc.

The distal end 64 of the first portion 52 of the platform 50 is configured to be releasably engageable with the proximal end 90 of the second portion 80 of the platform 50, which may include tooth and groove connections or the like (not shown). When the first portion 52 of the platform 50 is connected to the second portion 80, the passage 66a in the first portion 52 is aligned with the passage 94a in the second portion 80. Likewise, the passage 66b in the first portion 52 is aligned with the passage 94b in the second portion 80. The engagement of the first portion 52 with the second portion 80 thus us creates two continuous air passages within the assembled platform. The first passage extends from the top surface 82 of the second portion 80, through, opening 100 and opening 96a, from the passage 94a in the second portion 80 to the passage 66a in the first portion 52, and out of the first portion 52 via the opening 68a. The second passage extends from the top surface 82 of the second portion 80, through opening 101 and opening 96b, from passage 94b in the second portion 80 to the passage 66b in the first portion 52, and out of the first portion 52 via the opening 68b. It will be appreciated to those skilled in the art that a single passage between the first portion 52 and the second portion 80 having multiple openings disposed at its ends may be utilized instead of using the two passages depicted.

A flexible hose 108 may be disposed between the first portion 52 and the second portion 80 of the platform 50 within the air passage 66a and the air passage 94a, respectively. The first hose 108 is attached at one end to the nozzle 70 disposed within opening 68a and at the other end to a hose fitting 114 disposed within the passage 94a. The fitting 114 is preferably a T-shaped barbed hose fitting. The fitting 114 receives an end of the hose 108, and is either directly or indirectly (via another small piece of hose) attached to the valve 130 disposed within the opening 96a. An additional piece of hose 112 is attached at one end to the fitting 114 and at another end to the fitting 102 disposed within the opening 100 and coupled to the inflation means 104.

A third hose 110 is attached at one end to the nozzle 70 disposed within opening 68b and at the other end to a hose fitting 118 disposed within the passage 94b. The fitting 118 is preferably a T-shaped barbed hose fitting. The fitting 118 receives an end of the hose 110, and is either directly or indirectly (via another small piece of hose) attached to the valve 132 disposed within the opening 96b. An additional piece of hose 116 is attached at one end to the fitting 138 and at another end to the fitting 103 disposed within opening 101 and coupled to the inflation means 104. In this configuration, the openings 101, 96b, 68b are in fluid communication with each other, as are the openings 100, 96a, 68a whether the first portion 52 of the platform 50 is secured to the second portion 80 of the platform 50 or not. Furthermore, the openings 101, 96b, 68b are in fluid communication with the openings 100, 96a, 68a via the inflation means 104. It will be understood to those in the art that all hoses may be omitted, which would still allow all openings to be in fluid communication with each other, once the first, portion 52 of the platform 50 is connected to the second portion 80 of the platform 50 to align the passages 66a, 66b in the first portion 52 with the passages 94a, 94b in the second portion 80, respectively.

The length of the hoses 108, 110 is such that the each hose is taught when the first portion 52 of the platform 50 is not connected to the second portion 80 (FIGS. 5-6A). This allows the first portion 52 to be stacked onto the second portion 80 to reduce the overall size of the platform 50 for easier storage and transport. This is accomplished by bending the portion of the hoses 108, 110 in between the first portion 52 and the second portion 80.

When the first portion 52 is moved in the direction indicated by “B” to engage the second portion 80, the taught hoses 108, 110 becomes slacked (FIG. 6B). The slack in the hose 108 is maintained within the passage 66a, 94a while the slack in the hose 110 is maintained within the passage 66b, 94b. This allows the openings 100, 96a, 68a to remain in fluid communication with each other, and the openings 101, 96b, 68b to remain in fluid communication with each other.

The inflation means 104 is fastened to the top surface 82 of the second portion 80 of the platform 50 to provide inflation fluid to the decoy system 10. The inflation means 104 may comprise an air canister or air pump and is in fluid communication with the fitting 102 in the opening 190, and thus is in fluid communication with the hose 112. The inflation means 104 is also in fluid communication with the fitting 103 in the opening 101, and thus is in fluid communication with the hose 116. As will be discussed, since the inflation means 104 is in fluid communication with the hoses 112, 116, the inflation means 104 is able to provide inflation fluid, namely ah, to the hoses 112, 116 to cause the body 20 to become inflated.

A remote control or radio controlled unit 106 is also disposed on the top surface 82 of the second portion 80 of the platform 50, and is in electrical communication with the inflation means 104. This allows the inflation means 104 to be activated or turned off from, a remote location using a remote activator or button, as opposed to manually turning it on or off.

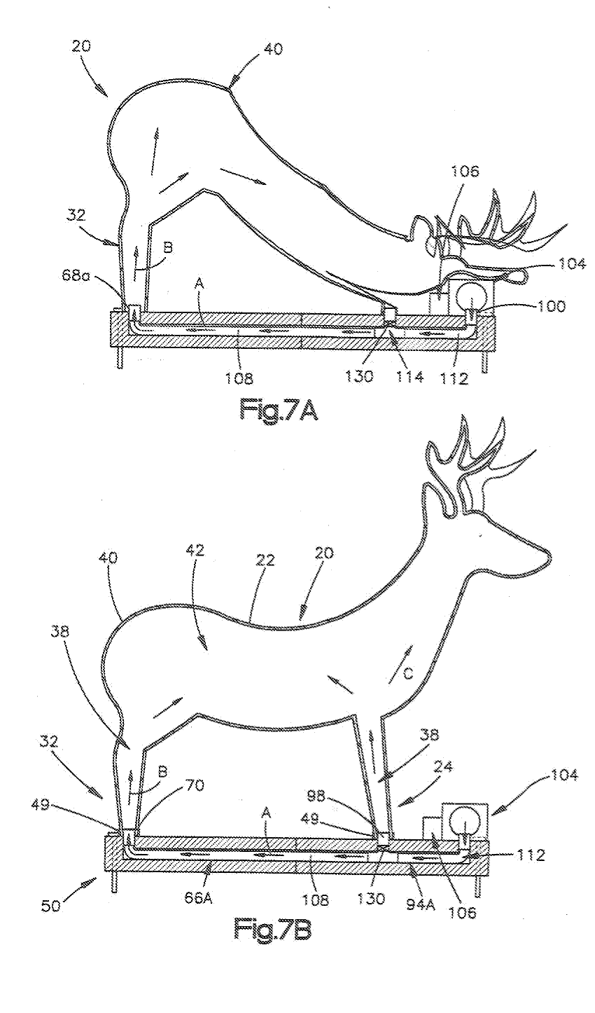

After the first portion 52 of the platform 50 has been secured to the second portion 80, the body 20 can be secured to the platform 50. As shown in FIG. 7, the opening 28 at the distal end 26 of each front leg 24 is placed over the nozzle 98 in the opening 96a and the opening 96b, respectively. Likewise, the opening 36 at the > distal, end 34 of each rear leg 32 is placed over the nozzle 70 in the opening 68a and the opening 68b, respectively. Each leg 24, 32 is then held in place by a clamp 49, which creates an air-tight seal between each nozzle 70 and each respective air passage 66a, 66b and each nozzle 98 and each respective air passage 94a, 94b, all of which lead to the inflatable inner chamber 42.

The operation of the decoy system 10 is depicted in FIGS. 7A-8C. Once the hunter designates the spot to use and deploy the decoy system 10, the system 10 is unpacked from a carry bag and the bottom, surface of 56 of the first portion 52 of the platform 50 and the bottom surface 84 of the second portion 80 of the platform 50 are placed on the ground. The first portion 52 and second portion 80 are then connected and the stakes 120, 124 are placed through the respective holes in the first portion 52 and second portion 80 of the platform and the pointed ends 122, 126 are driven into the ground to secure the system 10 to the ground. If the body 20 needs to be attached to the platform 50, the steps mentioned above are performed—otherwise the system 10 is ready for use. The hunter then selects his hiding spot at a distance from the decoy system 10 and waits. When he decides the timing is right, he activates the remote control unit 106 to turn the inflation means 104 on.

When the inflation means 104 is remotely activated, air is pumped into the through the fitting 102, the air hose 112, through the fitting 114, and into the hose 108, as indicated by arrows “B”. The air exits the platform 50 via the nozzle 70 in the opening 68a and thereafter enters the air passage 38 in the rear leg 32 of the body 20, inflating it. Air is likewise pumped through the fitting 103, into the air hose 116, through the fitting 118, and into the hose 110 (not shown), subsequently exits, the platform 50 via the nozzle 70 in the opening 68b, and thereafter enters the air passage 38 in the other rear leg 32 of the body 20, inflating it.

Initially, the body 20 is in a fully deflated condition as shown in FIG. 8A. As the inflation means 104 is activated and begins to pump inflation fluid, the rear legs 32 and portions of the torso 40 begirt to Inflate first. Since the valve 130 within the opening 96a and the valve 132 within the opening 96b are initially closed, inflation fluid is initially prohibited from reaching the nozzles 98, and thus the air passages 30 within the front legs 24 of the body 20. Thus, the inflation of the body 20 initially occurs solely through the rear legs 32, as shown in FIGS. 7A and 8B. Once a predetermined pressure has been reached within the body 20, the valves 130, 132 become opened, which allows inflation fluid to flow through the nozzles 98 in the second portion 80 of the platform 50 and thereafter into the air passages 30 in the front legs 24 of the body 20 as indicated by the arrows “C” in FIG. 7B. This inflation occurs simultaneously with continued inflation via the rear legs 32. This allows the entire body 20 to inflate to the condition shown in FIG. 8C, wherein the torso 40, the from legs 24, the rear legs 32, the head 44, and the antlers 46 are sufficiently filled with inflation fluid from the inflation means 104 that the body 20 maintains an upright, inflated condition mimicking that of a real, live animal. Inflation of approximately half of the entire body 20 is sufficient to create the upright condition of the body 20, but further inflation may be desired. Once the body 20 has obtained the desired inflated condition, the inflation means 104 can be remotely shut off to cut off the supply of inflation fluid to the body 20. The air-tight construction of the body 20, the nozzles 70, 98, the hoses 108, 110, 112, 114, and the inflation means 104 ensure that the body 20 maintains the inflated condition for extended periods of time.

When the hunter wishes to pack up the decoy system 10 and return home, he opens the baffle 48 disposed on the torso 40 to release the inflation fluid from the inflatable inner chamber 42 of the body 42. Once all the inflation fluid has been released from the entirety of the body 20, the body 20 can be removed from the platform 50 by removing the clamps 49 holding each front, leg 24 and rear leg 32 to each nozzle 70, 98, respectively, and then subsequently detaching the first portion 52 of the platform 50 from the second portion 80 until the first portion 52 can be stacked on top of the second portion 80 to allow the platform 50 to be easily stored in a bag or the like. Alternatively, the body 20 can remain attached to the platform 50 and can be folded up between the stacked first portion 52 and the second portion 80 of the platform 50 in storage after the platform 50 has been disassembled. This configuration thereby affords the hunter or landowner with an easily moveable and deployable decoy system 10 that can be operated from a remote location.

Although it has been suggested that all four legs are in direct fluid communication with a fluid passage within the platform, those in the art will understand that it is possible that the platform exhibits only one fluid passage, which allows one of the rear legs and one of the front legs to act as inflation points via openings. In such a case, the remaining front leg and rear leg will still be secured to the second portion and first portion of the platform, respectively, in an air-tight manner (not shown).

As a further alternative, the body may comprise only a single front leg and a single rear leg, whereby a single air passage within the platform maintains a single hose that supplies inflation fluid from the inflation means to the front leg and rear leg. This configuration simplifies inflation of the body and provides: fewer fluid connection points where leakage could occur.

From the above description of the invention, those skilled in the art will perceive improvements, changes and modifications. For example, the remote activation of the inflation means 104 to inflate the body 20 may be mechanically and/or electrically accomplished. This may include the use of wireless technology to activate solenoids, springs, cams, or the like. A timer may also be incorporated should the particularized use of the decoy system 10 require it. Such improvements, changes and modifications within the skill of the art are intended to be covered by the appended claims.

Having described the invention, the following is claimed:

1. An animal decoy comprising:
a body having an outer wall defining an inflatable inner chamber;
a platform having a fluid passage therein and at least one nozzle disposed thereon in fluid communication with the fluid passage, the body being releasably attached to the at least one nozzle to place the inflatable inner chamber in fluid communication with the fluid passage; and
a means for inflating the body secured to the platform and in fluid communication with the fluid passage to provide Inflation fluid to the fluid passage, the inflation means being actuated remotely to supply inflation fluid to the fluid passage and inflatable inner chamber to inflate the body.

2. The animal decoy of claim 1, wherein the body comprises at least one front leg and at least one rear leg.

3. The animal decoy of claim 2, wherein the at least one nozzle comprises a first nozzle and a second nozzle, the at least one front leg being releasably attached to the first nozzle and the at least one rear leg being releasably attached to the second nozzle.

4. The animal decoy of claim 3, wherein a valve is coupled to the first nozzle.

5. The animal decoy of claim 4, wherein the valve has a closed first condition wherein inflation fluid flows into the at least one rear leg first to inflate the body, the valve having an open second condition upon the reaching of a predetermined pressure across the valve to allow inflation fluid to flow through the first nozzle and the at least one first leg to further inflate the body.

6. The animal decoy of claim 1, wherein the body comprising the shape of one of an elk, rabbit, caribou, moose, goose, deer, turkey, or fox.
